(19) United States
(12) Patent Application Publication
(10) Pub. No.: US 2025/0033890 A1
(43) Pub. Date: Jan. 30, 2025

(54) Method, Conveyor and Conveying System for Transporting Products

(71) Applicant: Rexnord FlatTop Europe B.V., 's-Gravenzande (NL)

(72) Inventors: Cornelis Hendrik Mijndert Menke, Den Haag (NL); Leonardus Adrianus Catharinus Cornelissen, Den Haag (NL)

(21) Appl. No.: 18/715,862

(22) PCT Filed: Dec. 2, 2022
(86) PCT No.: PCT/NL2022/050695

§ 371 Date: Jun. 3, 2024

(30) Foreign Application Priority Data
Dec. 3, 2021 (NL) 2030029

(51) Int. Cl. B65G 17/24; B65G 47/26

(52) U.S. Cl. CPC B65G 17/24; B65G 47/26

(57) ABSTRACT

Method for transporting products, wherein an endless conveyor mat provided with product support rollers is guided forward in a conveying direction with a conveyor track and, via rounding elements adjacent to terminal ends of the conveyor track, is guided back with a return track, wherein on a conveying part of the conveyor mat, which is located on the conveyor track, products are carried on product support rollers of the conveyor mat so as to be transported, and wherein in a terminal end of the conveyor track adjacent to the rounding element, via support rollers of the conveyor mat, in conveying direction force is exerted on products being carried. Conveyor for transporting products, in particular for transporting products with a method as described above, comprising a conveyor track extending between rounding elements, and an endless conveyor mat provided with product support rollers, which conveyor mat comprises a conveying part in which products to be transported can be carried on product support rollers of the conveyor mat, which conveying part is supported on the conveyor track and in a conveying direction can be guided forward over the conveyor track, and which conveyor mat further comprises a return part which via the rounding elements can be guided back with a return track extending between the rounding elements, wherein a terminal end of the conveyor track adjacent to the rounding element is provided with engagers cooperating with the product support rollers, the engagers exerting force via the product support rollers of the conveyor mat in the conveying direction on products to be transported.

The invention generally relates to transportation of products with conveyor mats, and more particularly to transportation of products on conveyors with so-called roller mats.

Conveyor mats are generally known and are used for transporting products. In the case of so-called roller mats, also referred to by the term of modular LBP (Low Back Pressure) conveyor mats, the conveying surface of the conveyor mat is provided with product support rollers for carrying products to be transported. The product support rollers are usually of cylindrical configuration but can also have, for example, a spherical shape.

The product support rollers may be included in the conveyor mat. In such a case, the product support rollers can be bearing-mounted on the hinge pins which connect in conveying direction successive conveyor mat modules from which the conveyor mat is built up, and which extend transversely to the conveying direction. The product support rollers are then provided with shaft holes through which the hinge pins extend. The product support rollers are then bearing-mounted on the hinge pins in such a manner that the outer surfaces of the product support rollers project at least partly above the tops of body parts of the conveyor mat modules. In such a construction, the product support rollers usually have their outer surfaces projecting partly below the bottoms of the conveyor mat modules. Examples of such modular roller mats are Rexnord 1005 XLBP, the Intralox 1000 series, Movex 530 LBP and Habasit 2520 Roller Top.

In product transportation, a conveyor mat provided with product support rollers is formed into an endless loop. The conveyor mat is then guided forward in a conveying direction with a conveyor track and, via rounding elements adjacent to terminal ends of the conveyor track, is guided back with a return track, wherein on a conveying part of the conveyor mat that is located on the conveyor track, products are carried on product support rollers of the conveyor mat so as to be transported. A product being carried on the product support rollers can be arrested while the conveyor mat continues to move, without thrust being exerted on the product.

Although counteracting thrust with the product support rollers provides great advantages, it also has disadvantages: at the terminal ends of the conveyor track adjacent to the rounding elements, products supplied and to be discharged can accumulate in that the products remain at a standstill relative to the conveyor mat.

Object of the invention is, while preserving the advantages mentioned, to counteract the disadvantages mentioned at least partly.

To this end, the invention provides a method for transporting products, wherein an endless conveyor mat provided with product support rollers is guided forward in a conveying direction with a conveyor track and, via rounding elements adjacent to terminal ends of the conveyor track, is guided back with a return track, wherein on a conveying part of the conveyor mat, which is located on the conveyor track, products are carried on product support rollers of the conveyor mat so as to be transported, and wherein in a terminal end of the conveyor track adjacent to the rounding element, via product support rollers of the conveyor mat, in conveying direction force, in particular thrust, is exerted on products carried on the product support rollers.

Via the product support rollers, thus, force can be exerted on the products carried by the product support rollers, for instance on an undersurface of the product. In this way, at a terminal end located at the beginning and/or end of the conveyor track adjacent to the rounding element, via the product support rollers thrust can be transmitted onto the products. Thus, in a terminal end of the conveyor track located at the beginning of the conveyor track adjacent to the rounding element, via the product support rollers force can be exerted to carry supplied products along with the conveyor mat in conveying direction and thus pull them over the rounding element up the conveyor track on the conveyor mat, and/or with a terminal end located at the end of the conveyor track adjacent to the rounding element, via the product support rollers, thrust can be transmitted onto the products to carry to-be-discharged products along with the conveyor mat in conveying direction and thus push them over the rounding element off the conveyor track.

Via the product support rollers, force, in particular driving force in conveying direction, can be exerted on the products to push these into a transport zone adjacent to the rounding element, located downstream in the plane of the conveyor track, and/or via the product support rollers, force can be exerted on the products to pull these from a conveying zone adjacent to the rounding element, located upstream in the plane of the conveyor track. The force can then be exerted while the conveying part is supported via a support surface on the terminal end of the conveyor track.

The product support rollers may be included in the conveyor mat in a freely rotating manner, and the force mentioned may be exerted in that in the terminal end of the conveyor track adjacent to the rounding element, free rotation of product support rollers is canceled. The product support rollers may then be included in the mat as Low Back Pressure (LBP) rollers, and may for instance transmit force onto the supported products in that they engage with engagers included in the terminal end of the conveyor track, the engagers causing the product support rollers to rotate, for instance by movement of the conveyor mat relative to the conveyor track in conveying direction.

The product support rollers can be relatively simply driven from the lower side of the conveyor mat modules to transmit force onto the supported products, for instance by means of friction with a strip in the track guide, that is stationary relative to the modular conveyor mat, or an actively driven driving roller. The product support rollers may also be driven in a noncontact manner, for instance by means of magnetic induction.

The conveyor mat is preferably configured as a modular conveyor mat, but may also be of nonmodular design. The rounding element may or may not be driven, and may for instance be configured as a sprocket wheel which may or may not be driven or as a stationary rounding element such as a nose-over.

The force may be exerted on the supported products via the product support rollers in that onto the product support rollers a couple is transmitted, for instance from the conveyor track. Thus, engagers may be arranged in the terminal end of the conveyor track, which engagers engage the product support rollers directly or indirectly. Elegantly, the engagers are in a lying, flat conveyor track's terminal end which extends from or up to the rounding elements.

The product support rollers may for instance be rigidly arranged on a shaft, and the shaft may be provided with a driving element which is engaged indirectly by an engaging element on the conveyor track. Also, product support rollers may be mounted on a shaft in a freely rotatable manner and be engaged directly in that an engaging element of the conveyor track makes contact with the product support roller, for instance with a lower side of the circumference of the product support roller.

The couple may be exerted on the product support rollers by blocking or braking rotation of the product support rollers. Thus, via the product support rollers, force can be exerted on the supported products so as to have them move along with the conveying part.

The couple may advantageously be exerted by driving of rotation of the product support rollers. The driving force can then be used to accelerate the product relative to the conveying part, for instance in order to make the interspace between successive supplied products on the conveyor mat small, or in order for products to-be-discharged to be ‘shot’ in conveying direction. Driving of rotation may for instance be carried out by rolling of the circumference of the product support roller on a stationary contact element of the conveyor track or on an actively driven contact element of the conveyor track.

The couple, as said, may be exerted by cooperation of a contact element of the conveyor track with the circumference of the product support roller, for instance by cooperation of a stationary contact element included in the conveyor track with the circumference of a product support roller included in the conveyor mat, which moves with the conveyor mat in conveying direction over the conveyor track. The contact element may then, transversely to the conveying direction, have the width of a product support roller, and/or extend in conveying direction to cooperate with a single row of product support rollers successive in conveying direction. Transversely to the conveying direction, a plurality of contact elements may be spaced apart, thereby forming a comb. Such a comb of contact elements may then adjoin a stationary rounding element, in particular a nose-over, or may even be integrated therewith.

Products may, near a terminal end located at the end of the conveyor track, with the aid of the force exerted via the product support rollers on the products, be pushed off the conveying part of the conveyor mat, into an adjacent transport zone located in conveying direction beyond the rounding element, for instance in the last 5-50 cm up to the rounding surface of the rounding element, in particular the last 10-25 cm up to the rounding surface of the rounding element, and specifically around the last 15 cm up to the rounding surface of the rounding element.

Products may, near a terminal end located at the beginning of the conveyer track, with the aid of the force exerted via the product support rollers on the products, be pulled onto the conveying part of the conveyor mat from an adjacent transport zone located in conveying direction before the rounding element, for instance in the first 5-50 cm from the rounding surface of the rounding element, in particular the first 10-25 cm from the rounding surface of the rounding element, and specifically around the first 15 cm from the rounding surface of rounding element.

At an end-side transition between successive conveyor tracks, via product support rollers force can be exerted on products to be transported in order to have the products pass a driveless transition area located between adjacent rounding elements, extending in the plane of the conveyor tracks. In addition, via product support rollers of a conveyor located upstream of the transition area, force can be exerted on the products to thrust these into the transition area and/or via product support rollers of a conveyor located downstream of the transition area, force can be exerted on the products to pull them from the driveless area.

The invention also relates to a conveyor for transporting products, in particular for transporting products with a method as described hereinabove, comprising a conveyor track extending between rounding elements, and an endless conveyor mat provided with product support rollers, which conveyor mat comprises a conveying part in which products to be transported can be carried on product support rollers of the conveyor mat, which conveying part is supported on the conveyor track and in a conveying direction can be guided forward over the conveyor track, and which conveyor mat further comprises a return part which via the rounding elements can be guided back with a return track extending between the rounding elements, wherein a terminal end of the conveyor track adjacent to the rounding element is provided with engagers cooperating with the product support rollers, which engagers exert force via the product support rollers of the conveyor mat in the conveying direction on products to be transported. The conveyor mat is preferably implemented as a modular conveyor mat, but may for instance also be implemented as a flexible endless mat in one piece provided with product support rollers.

The product support rollers may be included in the conveyor mat in a freely rotating manner. Elegantly, the product support rollers, at the upper side of the conveyor mat, have a part of their circumference projecting above the surface of the conveyor mat, while the conveyor mat, at the lower side, has its underside supported on the conveyor track while leaving the circumference of the product support rollers free.

At least one rounding element is elegantly implemented as a stationary rounding element, in particular as a nose-over with a curved rounding surface in the same order of magnitude as the pitch of the modules, or with at least a part of the surface having a radius of curvature that is between 1-5 cm.

The engagers in the terminal end of the conveyor track preferably comprise contact elements which make direct contact with the lower side of the circumference of the product support roller. The product support rollers can then roll over a contact element of the track. Alternatively, the contact element can actively drive the product support rollers, for instance by rotation or translation of the contact element itself relative to the conveyor track. The product support rollers may also be driven indirectly, for instance by driving of the hinge pin which they have been fitted on. The (in) direct drive may also be executed in a contactless manner, for instance by means of magnetic induction.

The engagers, in particular the contact elements, are preferably in a lying, flat part of the terminal end of the conveyor track. Transversely to the conveying direction, the width of the contact element can correspond to the width of the product support roller, and transversely to the conveying direction a plurality of contact elements may be spaced apart with mutual interspace. The conveying part can then, in the interspaces via a support surface, be supported on the terminal end of the conveyor track. Thus, the conveyor mat can preserve its contact with the conveyor track during the cooperation of the conveyor track with the product support rollers, which is of benefit to the stability of the products supported on product support rollers during supply and/or discharge.

The contact element extends in the conveying direction preferably along a single row of product support rollers. Thus, a row of product support rollers of successive modules in the conveyor mat that have the same position transverse to the conveying direction can cooperate with the contact element at the same time. Thus, rows of product support rollers being adjacent to each other transversely to the conveying direction can cooperate separately with a contact element, so that products as desired may or may not be manipulated with specific rows.

The contact element can elegantly, on a side, adjoin a rounding element. The contact element, when it is located at the end of the conveyor track, can extend over the last 5-50 cm of the conveyor track up to the rounding surface of the rounding element, in particular over the last 10-25 cm up to the rounding surface, and specifically over around the last 15 cm. If the contact element is located at the end of the conveyor track, it can extend over the last 5-50 cm of the conveyor track up to the rounding surface of the rounding element, in particular over the last 10-25 cm, and specifically over around the last 15 cm.

The invention also relates to a conveying system comprising two conveyors as described hereinbefore successively disposed in an end-side transition with adjacent rounding elements and, therebetween, a driveless transition area located in the plane of the successive conveyor tracks, wherein in terminal ends of the conveyor track adjacent to the rounding element, downstream and/or upstream of the transition area, via product support rollers of the conveyor mat, in conveying direction force is exerted on products to have these pass the transition area.

The invention further relates to a stationary rounding element for a conveyor for transporting products, comprising a nose-over having a curved rounding surface and strip-shaped contact elements located in a plane, spaced apart with mutual interspace transversely to a conveying direction, which contact elements extend in the conveying direction up to the nose-over, and having a terminal end adjoining the nose-over, so that a comb adjoining the nose-over is formed.

As regards the disclosure made here, it is noted that the above-mentioned technical measures, whether or not included in a dependent claim, may also each per se be used to advantage, and if desired can also be used in random combinations. This also concerns combination of the discussed measures separately or in any combination where not all measures of the independent claims are used.

The invention will be further explained on the basis of a nonlimiting exemplary embodiment which is represented in a drawing. In the drawing:

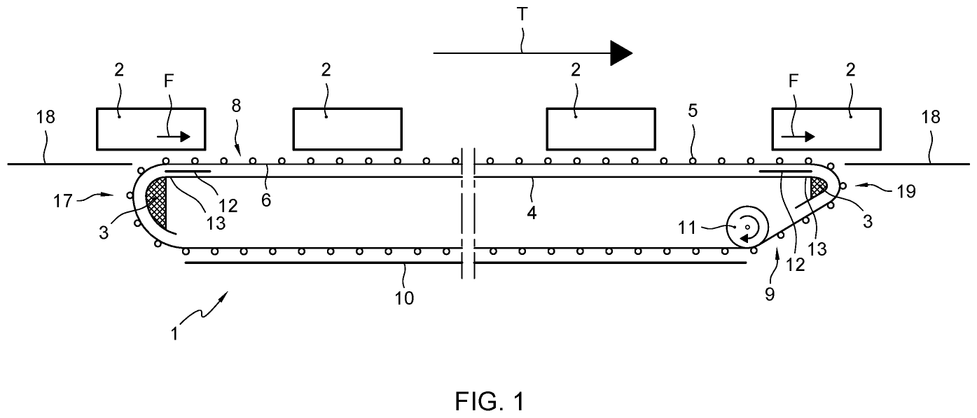

FIG. 1 shows a schematic side view of a conveyor for transporting products;

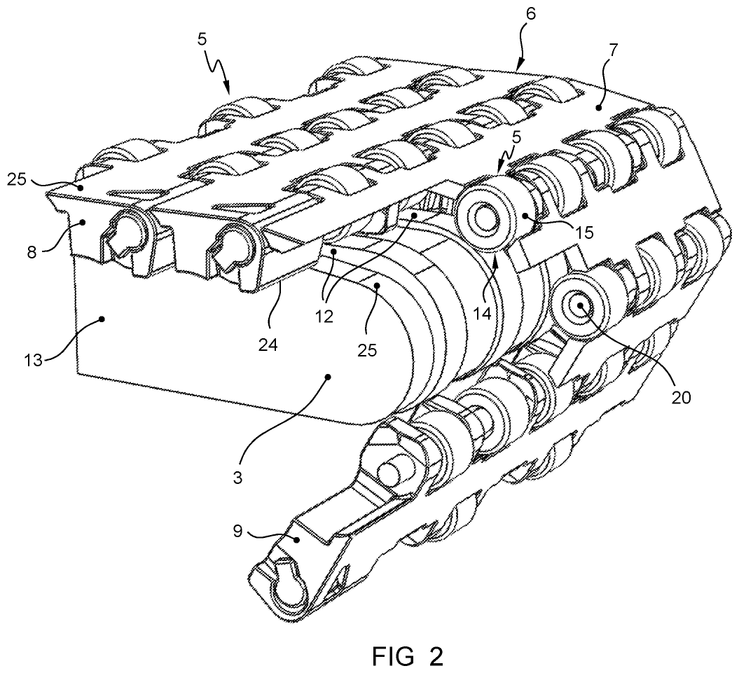

FIG. 2 shows a schematic perspective view of a terminal end of the conveyor track of the conveyor of FIG. 1 where the conveyor mat runs around a rounding element, and

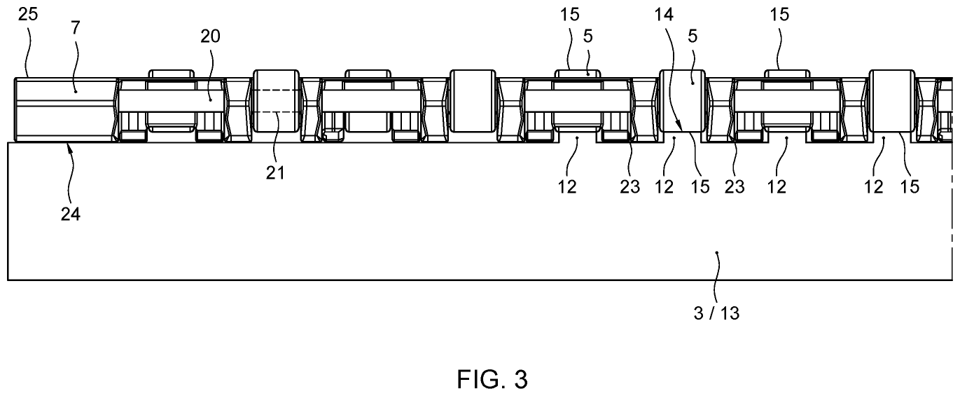

FIG. 3 shows a schematic cross section of the terminal end shown in FIG. 2.

It is noted that the figures are merely schematic representations of a preferred embodiment of the invention. In the figures, like or corresponding parts are represented with the same reference numerals.

FIG. 1 shows a conveyor 1 for transporting products 2. The conveyor 1 comprises a conveyor track 4 extending between rounding elements 3, and an endless conveyor mat 6 provided with product support rollers 5. The conveyor mat 6 is implemented as a modular conveyor mat 6 assembled from conveyor mat modules 7, and is described in more detail in the exemplary embodiment set out, with reference to FIGS. 1-9, on page 10, line 21 to page 14, line 30 of applicant's non-prepublished patent application PCT/NL2021/050358.

The conveyor mat 6 comprises a conveying part 8 in which products 2 to be transported are carried on product support rollers 5 of the conveyor mat 6. The product support rollers 5 in this example are implemented as LBP rollers which are included in the conveyor mat 6 in a freely rotating manner. The conveying part 8 is supported on the conveyor track 4 and is guided forward in a conveying direction T over the conveyor track 4. The conveyor mat 6 comprises a return part 9 which via the rounding elements 3 is guided back with a return track 10 extending between the rounding elements 3. The rounding elements 3 in this example are stationary, and are each implemented as a nose-over 3. The conveyor mat 6 is driven with the aid of a driving gearwheel 11 included in the return part 9.

As shown in the detail of FIGS. 2 and 3, a terminal end 13 of the conveyor track 4, adjacent to the rounding element 3, is provided with engagers 12 cooperating with the product support rollers 5. The engagers 12 exert, via the product support rollers 5 of the conveyor mat 6, in conveying direction T a force F on products 2 to be transported.

The engagers 12 in the terminal end 13 of the conveyor track 4 are implemented as strip-shaped contact elements 12 in a lying, flat part of the terminal end 13 of the conveyor track 4. The strip-shaped contact elements 12 extend up to the nose-over 3, and have a terminal end adjoining the nose-over 3.

The contact elements 12 make contact with the underside 14 of the circumference 15 of the product support roller. Transversely to the conveying direction T, the width of the contact element 12 corresponds to the width of the product support roller. The contact element 12 extends in the conveying direction T along a single row of product support rollers 5 so as to cooperate with a single row of product support rollers 5 successive in conveying direction T. Transversely to the conveying direction T, a plurality of contact elements 12 are spaced apart with mutual interspace, so that a comb 16 adjoining the nose-over 3 is formed.

In FIG. 3 it can be properly seen how the product support rollers 5 are included in the conveyor mat 6. The product support rollers 5 are bearing-mounted on the hinge pins 20 which connect in conveying direction successive conveyor mat modules 7 from which the modular conveyor mat 6 is built up, and which extend transversely to the conveying direction T. The product support rollers 5 are provided with shaft holes 21 through which extend the hinge pins 20. The product support rollers 5 are bearing-mounted on the hinge pins 20 in such a way that the outer surfaces 15 of the product support rollers project at least partly above the tops 22 of the body parts of the conveyor mat modules 7. The outer surfaces 15 of the product support rollers, however, run clear of the conveyor track 4. Transversely to the conveying direction T, the width of the contact element 12 corresponds to the width of the product support roller 5, and transversely to the conveying direction T a plurality of contact elements 12 are spaced apart with mutual interspace 23. The conveying part 8 is supported in the interspaces 23, via a supporting surface 24 of the conveyor mat modules 7 of the conveyor mat 6, on the terminal end 13 of the conveyor track 4. Thus, the conveyor mat 6, during the cooperation of the conveyor track 4 with the product support rollers 5, can preserve contact with the conveyor track 4 via the supporting surfaces 24, which is beneficial to the stability of the products 2 supported on the product support rollers 5, when being supplied or discharged.

The endless conveyor mat provided with product support rollers 5, during use, is guided forward in a conveying direction T with the conveyor track 4 and, via rounding elements 3 adjacent to terminal ends 13 of the conveyor track 4, is guided back with the return track 10. On the conveying part 8 of conveyor mat 6 that is on the conveyor track 4, products 2 are carried on product support rollers 5 of the conveyor mat 6, so as to be transported. In the terminal ends 13 of the conveyor track 4 adjacent to the rounding elements 3, there is exerted via product support rollers 5 of the conveyor mat 6 in conveying direction T a force F on products 2 carried on the product support rollers 5.

Thus is described a conveyor 1 for transporting products 2 comprising a conveyor track 4 extending between rounding elements, and an endless conveyor mat 6 provided with product support rollers 5. The conveyor mat 6 comprises a conveying part 8 in which products 2 to be transported can be carried on product support rollers 5 of the conveyor mat 6. The conveying part 8 is supported on the conveyor track 4 and can be guided forward in a conveying direction over the conveyor track 4. The conveyor mat 6 further comprises a return part 9 which via the rounding elements can be guided back with a return track 10 extending between the rounding elements. A terminal end 13 of the conveyor track 4 adjacent a rounding element implemented as a nose-over 3 is provided with engagers, in particular contact elements 12, cooperating with the product support rollers 5, which engagers exert, via the product support rollers 5 of the conveyor mat 6, force in conveying direction T on products 2 to be transported. The product support rollers 5 are included in the conveyor mat 6 in a freely rotating manner. The rounding element is a stationary rounding element. The engagers in the terminal end 13 of the conveyor track comprise contact elements 12 which make direct contact with the underside of the circumference of the product support roller 5. The engagers are in a lying, flat part of the terminal end 13 of the conveyor track 4. Transversely to the conveying direction T, the width of the contact element 12 corresponds to the width of the product support roller 5. The contact element 12 extends in conveying direction T along a single row of product support rollers 5. Transversely to the conveying direction T, a plurality of contact elements 12 are spaced apart with mutual interspace 23. The contact element 12 has a terminal end adjoining the rounding element 3.

Thus is described, further, a stationary rounding element for a conveyor for transporting products, comprising a nose-over 3 having a curved rounding surface 25 and strip-shaped contact elements 12 located in a plane, spaced apart with mutual interspace 23 transversely to a conveying direction T, which contact elements extend in the conveying direction T up to the nose-over 3, and have a terminal end adjoining the nose-over 3, so that a comb 16 adjoining the nose-over is formed.

In this exemplary embodiment, the product support rollers 5 are driven from the underside 14 of the conveyor mat modules 7 to transmit a force F on the supported products 2. The force F is exerted on the supported products 2 via the product support rollers 5 in that from the conveyor track 4 a couple is transmitted onto the product support rollers 5. In the last 15 cm of the terminal end 13 of the conveyor track 4 up to the rounding surface 25 of rounding element 3, the contact elements 12 engage the product support rollers 5, and the product support rollers 5 moving along with the conveyor mat 6 are driven to rotation by rolling of the circumference 15 of the product support roller 5 on the stationary contact element 12 of the conveyor track 4. Via the product support rollers 5, a force F is exerted on the products 2 so as to pull them, at the beginning 17 of the conveyor track 4, from a transport zone 18 adjacent to the rounding element 3, located upstream in the plane of the conveyor track 4, onto the conveyor mat 6 and so as to push them, at the end 19 of the conveyor track 4, off the conveyor mat 6 into a transport zone 18 adjacent to the rounding element 3, located downstream in the plane of the conveyor track 4.

The invention is not limited to the exemplary embodiment represented here, but can comprise many variants. Such variants will be clear to the skilled person and are understood to fall within the scope of the invention as defined in the appended claims.

### REFERENCE NUMERALS

1 Conveyor
2 Product
3 Rounding element/Nose-Over
4 Conveyor track
5 Product support roller
6 Conveyor mat
7 Conveyor mat modules
8 Conveying part
9 Return part
10 Return track
11 Driving gearwheel
12 Engager/Contact element
13 Terminal end
14 Underside
15 Circumference
16 Comb
17 Beginning
18 Transport zone
19 End
20 Hinge pin
21 Shaft hole
22 Top
23 Interspace
24 Supporting surface
25 Rounding surface
T Conveying direction
F Force

1. A method for transporting products, wherein an endless conveyor mat provided with product support rollers is guided forward in a conveying direction with a conveyor track and, via rounding elements adjacent to terminal ends of the conveyor track, is guided back with a return track, wherein on a conveying part of the conveyor mat, which is located on the conveyor track, products are carried on product support rollers of the conveyor mat so as to be transported, and wherein in a terminal end of the conveyor track adjacent to the rounding element, via support rollers of the conveyor mat, in conveying direction force is exerted on products carried on the product support rollers.

2. The method according to claim 1, wherein the support rollers are included in the conveyor mat in a freely rotating manner, and wherein said force is exerted in that in the terminal end of the conveyor track adjacent to the rounding element free rotation of product support rollers is canceled.

3. The method according to claim 1, wherein said force is exerted by transmission of couple onto the product support rollers.

4. The method according to claim 3, wherein the couple is exerted by blocking or braking of rotation of the product support rollers.

5. The method according to claim 3, wherein the couple is exerted by driving of rotation of the product support rollers.

6. The method according to claim 3, wherein the couple is exerted by cooperation of a contact element of the conveyor track with the circumference of the product support roller.

7. The method according to claim 1, wherein products, near a terminal end located at the end of the conveyor track, with the aid of the force exerted via the product support rollers on the products, are pushed off the conveying part of the conveyor mat into an adjacent transport zone located, in conveying direction, beyond the rounding element.

8. The method according to claim 1, wherein the products, near a terminal end located at the beginning of the conveyor track, with the aid of the force exerted via the product support rollers on the products, are pulled onto the conveying part from an adjacent transport zone located, in conveying direction, before the rounding element.

9. The method according to claim 1, wherein at the location of an end-side transition between successive conveyor tracks, via product support rollers force is exerted on products to be transported in order to have the products pass a driveless transition area located between adjacent rounding elements and located in the plane of the conveyor tracks.

10. A conveyor for transporting products, in particular for transporting products with a method according to claim 1, comprising a conveyor track extending between rounding elements, and an endless conveyor mat provided with product support rollers, which conveyor mat comprises a conveying part in which products to be transported can be carried on product support rollers of the conveyor mat, which conveying part is supported on the conveyor track and in a conveying direction can be guided forward over the conveyor track, and which conveyor mat further comprises a return part which via the rounding elements can be guided back with a return track extending between the rounding elements, wherein a terminal end of the conveyor track adjacent to the rounding element is provided with engagers cooperating with the product support rollers, which engagers exert force via the product support rollers of the conveyor mat in the conveying direction on products to be transported.

11. The conveyor according to claim 10, wherein the product support rollers are included in the conveyor mat in a freely rotating manner.

12. The conveyor according to claim 10, wherein the rounding element is a stationary rounding element.

13. The conveyor according to claim 10, wherein the engagers in the terminal end of the conveyor track comprise contact elements which make direct contact with the underside of the circumference of the product support roller.

14. The conveyor according to claim 10, wherein the engagers are in a lying, flat part of the terminal end of the conveyor track.

15. The conveyor according to claim 13, wherein transversely to the conveying direction, the width of the contact element corresponds to the width of the product support roller.

16. The conveyor according to claim 13, wherein the contact element extends in conveying direction along a single row of product support rollers, and/or wherein transversely to the conveying direction a plurality of contact elements are spaced apart with mutual interspace.

17. The conveyor according to claim 13, wherein the contact element has a terminal end adjoining the rounding element.

18. A conveying system comprising two conveyors according to claim 10, disposed in an end-side transition with adjacent rounding elements and therebetween a driveless transition area located in the plane of the successive conveyor tracks, wherein in terminal ends of the conveyor track adjacent to the rounding element, downstream and/or upstream of the transition area, via product support rollers of the conveyor mat, in conveying direction force is exerted on products to have these pass the transition area.

19. A stationary rounding element for a conveyor for transporting products, in particular a conveyor according to claim 15, comprising a nose-over with a curved rounding surface and strip-shaped contact elements located in a plane, spaced apart with mutual interspace transversely to a conveying direction, which extend in conveying direction up to the nose-over, and having a terminal end adjoining the nose over, so that a comb adjoining the nose-over is formed.

20. A stationary rounding element for a conveyor for transporting products, in particular a conveyor according to claim 18, comprising a nose-over with a curved rounding surface and strip-shaped contact elements located in a plane, spaced apart with mutual interspace transversely to a conveying direction, which extend in conveying direction up to the nose-over, and having a terminal end adjoining the nose over, so that a comb adjoining the nose-over is formed.
